(19) United States
(12) Patent Application Publication
(10) Pub. No.: US 2025/0368330 A1
(43) Pub. Date: Dec. 4, 2025

(54) SHADING AND UNSHADING OF AIRCRAFT WINDOWS

(71) Applicant: GOODRICH LIGHTING SYSTEMS, INC., Phoenix, AZ (US)

(72) Inventors: Pratap Mallampati, Bengaluru (IN); Sachin Badoor, Bangalore (IN); Varad Kamath, Bengaluru (IN)

(73) Assignee: GOODRICH LIGHTING SYSTEMS, INC., Phoenix, AZ (US)

(21) Appl. No.: 19/170,695

(22) Filed: Apr. 4, 2025

(30) Foreign Application Priority Data
May 30, 2024 (IN) 202441042139

(51) Int. Cl. B64D 11/00; B64C 1/14

(52) U.S. Cl. CPC B64D 11/00; B64C 1/1484; B64D 2011/0038; B64D 2011/0061

(57) ABSTRACT

A system for shading or unshading of an aircraft window is disclosed herein. The system includes the aircraft window, a photochromatic material coupled to the aircraft window, and a light source within a cabin of the aircraft. Responsive to exposing the photochromatic material to the light source, the photochromatic material transitions from a first state to a second state.

### CROSS-REFERENCE TO RELATED APPLICATIONS

This application claims priority to, and the benefit of, India Provisional Patent Application No. 202441042139, filed May 30, 2024 and titled “SHADING AND UNSHADING OF AIRCRAFT WINDOWS,” which is incorporated by reference herein in its entirety for all purposes.

### FIELD

The present disclosure generally relates to aircraft windows, and more specifically, to a shading and/or unshading of aircraft windows.

### BACKGROUND

Aircraft interiors includes aircraft window shade, which may also be referred to as shutters or blinds, are provided for passenger comfort and safety. In certain events, such as taxiing, takeoff, or landing, it may be important for windows within the aircraft to remain unobstructed for safety needs so that the aircraft crew may watch for an emergency condition during taxiing, takeoff, and landing and/or emergency blackout conditions within the aircraft cabin. In such events, the aircraft crew typically requests passengers to open all window shades in order for viewing outside the aircraft and to allow natural light to enter the aircraft during an emergency.

### SUMMARY

A system for shading or unshading of an aircraft window aircraft window is disclosed herein. The system includes the aircraft window, a photochromatic material coupled to the aircraft window, and a light source within a cabin of an aircraft. Responsive to exposing the photochromatic material to the light source, the photochromatic material transitions from a first state to a second state.

In various embodiments, the first state is a transparent and/or substantially transparent to a range of visible or invisible light wavelengths state. In various embodiments, the second state is an opaque and/or substantially opaque to the range of visible or invisible light wavelengths state.

In various embodiments, the first state is an opaque and/or substantially opaque to a range of visible or invisible light wavelengths state. In various embodiments, the second state is a transparent and/or substantially transparent to the range of visible or invisible light wavelengths state.

In various embodiments, the photochromatic material is coupled to an interior of the aircraft window. In various embodiments, the photochromatic material is responsive to a light wavelength in a range of 100 nm to 1 mm.

In various embodiments, the light source is at least one of an aircraft passenger reading light, a cabin light, an edge light, or a dedicated light source. In various embodiments, the light source outputs a light wavelength in a range of 100 nm to 1 mm.

In various embodiments, the photochromatic material is exposed to the light source by a passenger directing the light source either towards or away from the photochromatic material.

In various embodiments, the system further includes a crew member-controlled mechanism. In various embodiments, the crew member-controlled mechanism is coupled to the light source. In various embodiments, the photochromatic material is exposed to the light source by the crew member-controlled mechanism directing the light source either towards or away from the photochromatic material.

In various embodiments, the crew member-controlled mechanism is at least one of an actuator or a motor.

In various embodiments, the system further includes a controller. In various embodiments, the controller is configured to: receive an input from a crew member of the aircraft; and send a command to the crew member-controlled mechanism cause the crew member-controlled mechanism to direct a light of the light source on the photochromatic material.

In various embodiments, the system further includes a color filter or reflective coating. In various embodiments, the color filter or reflective coating is coupled to an exterior of the aircraft window.

Also disclosed herein is an aircraft. The aircraft includes a plurality of aircraft windows, a photochromatic material coupled to each of the plurality of aircraft windows; and a plurality of light sources within a cabin of the aircraft. Responsive to exposing the photochromatic material on each of the plurality of aircraft windows to a respective one of the plurality of light sources, the photochromatic material transitions from a first state to a second state.

In various embodiments, the first state is a transparent and/or substantially transparent to a range of visible or invisible light wavelengths state. In various embodiments, the second state is an opaque and/or substantially opaque to the range of visible or invisible light wavelengths state.

In various embodiments, the first state is an opaque and/or substantially opaque to a range of visible or invisible light wavelengths state. In various embodiments, the second state is a transparent and/or substantially transparent to the range of visible or invisible light wavelengths state.

In various embodiments, the photochromatic material is coupled to an interior of each of the plurality of aircraft windows. In various embodiments, the photochromatic material is responsive to a light wavelength in a range of 100 nm to 1 mm.

In various embodiments, each light source of the plurality of light sources is at least one of an aircraft passenger reading light, a cabin light, an edge light, or a dedicated light source. In various embodiments, the light source outputs a light wavelength in a range of 100 nm to 1 mm.

In various embodiments, the photochromatic material on each of the plurality of aircraft windows is exposed to a respective light source of the plurality of light sources by a passenger directing the respective light source either towards or away from the photochromatic material on a respective aircraft window of the plurality of aircraft windows.

In various embodiments, the aircraft further includes a plurality of crew member-controlled mechanisms. In various embodiments, each crew member-controlled mechanism of the plurality of crew member-controlled mechanisms is coupled to a respective light source of the plurality of light sources and wherein the photochromatic material on each of the plurality of aircraft windows is exposed to the respective light source by a respective crew member-controlled mechanism directing the respective light source either towards or away from the photochromatic material on a respective aircraft window of the plurality of aircraft windows.

In various embodiments, the plurality of crew member-controlled mechanisms are at least one of an actuator or a motor.

In various embodiments, the aircraft further includes a controller. In various embodiments, the controller is configured to: receive an input from a crew member of the aircraft; and send a command to each of the plurality of crew member-controlled mechanisms causing the plurality of crew member-controlled mechanisms to direct a light of a respective light source of the plurality of light sources on the photochromatic material of a respective aircraft window of the plurality of aircraft windows.

In various embodiments, the aircraft further includes a color filter or reflective coating coupled to an exterior of each of the plurality of aircraft windows.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft and various sections within the aircraft, in accordance with various embodiments.

FIG. 2 illustrates an interior view of a passenger cabin of an aircraft, in accordance with various embodiments.

FIG. 3A illustrates a schematic longitudinal cross-sectional view of a section of a passenger cabin, in accordance with various embodiments.

FIG. 3B illustrates a schematic view of an overhead passenger service unit (“PSU”), in accordance with various embodiments.

FIGS. 4A and 4B illustrate an aircraft window shading/unshading system, in accordance with various embodiments.

FIGS. 5A and 5B illustrate an aircraft window shading/unshading system, in accordance with various embodiments.

FIGS. 6A and 6B illustrate an aircraft window shading/unshading system, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

As previously stated, in certain events, such as taxiing, takeoff, or landing, it may be important for windows within the aircraft to remain unobstructed for safety needs so that the aircraft crew may watch for an emergency condition during taxiing, takeoff, and landing and/or emergency blackout conditions within the aircraft cabin. In such events, the aircraft crew typically requests passengers to open all window shades in order for viewing outside the aircraft and to allow natural light to enter the aircraft during an emergency.

Disclosed herein is a system where physical shades are no longer needed in an aircraft and the windows are coated with a photochromatic material. In various embodiments, the photochromatic material is transparent and/or substantially transparent to a range of visible light wavelengths, which allows natural light from outside of the aircraft to enter a cabin of the aircraft. In various embodiments, the photochromatic material is responsive to a predetermined range of light wavelengths, such as certain visible or invisible light wavelengths provided by an aircraft interior light. In that regard, in various embodiments, in response to the photochromatic material on the window being exposed to the light wavelengths emitted by interior light sources of the aircraft, the photochromatic material will turn opaque and/or substantially opaque when exposed to a range of visible or invisible light wavelengths, thereby preventing the natural light from outside the aircraft from entering the cabin of the aircraft as well as preventing viewing outside the aircraft from the cabin.

In various embodiments, the photochromatic material is substantially opaque to visible light and natural light from outside the aircraft is prevented from entering the cabin of the aircraft. In various embodiments, the photochromatic material is responsive to a predetermined range of light wavelengths, such as certain visible or invisible light wavelengths provided by an aircraft interior light. In that regard, in various embodiments, in response to the photochromatic material on the window being exposed to the light wavelength of the aircraft interior light, the photochromatic material will turn transparent when exposed to a range of visible or invisible light wavelengths, thereby allowing the natural light from outside the aircraft to enter the cabin of the aircraft and allow viewing outside the aircraft from the cabin.

In various embodiments, the aircraft interior light may be a passenger reading light, a cabin light, an edge light, or a dedicated light source, among others. In various embodiments, the aircraft interior light may include visible or invisible light source. In various embodiments, responsive to the aircraft interior light being a passenger reading light, then the passenger reading light may be coupled to a crew member-controlled mechanism. In that regard, responsive to an event, such as taxiing, takeoff, landing, or emergency, among others, a crew member may provide input to a controller that sends a command to the crew member-controlled mechanism, which may be a motor, actuator, or other mechanism, that, responsive to receiving the command, turns the passenger reading light towards the photochromatic material on the window thereby causing the photochromatic material to transition, which reduces passenger involvement and crew member manual checks.

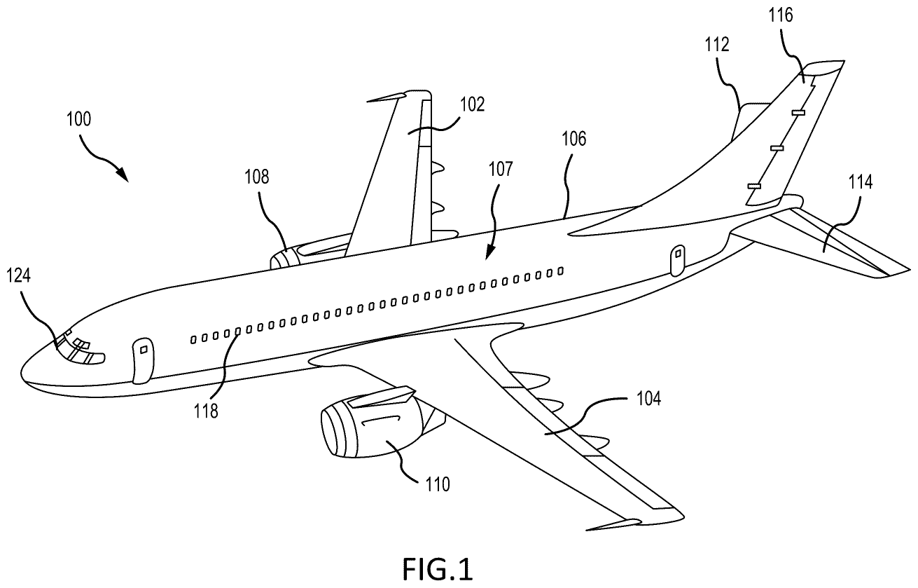

Referring now to FIG. 1, an aircraft 100 and various sections within the aircraft is illustrated, in accordance with various embodiments. Aircraft 100 is an example of a passenger or transport vehicle in which a cooling system may be implemented in accordance with various embodiments. In various embodiments, aircraft 100 has a starboard wing 102 and a port wing 104 attached to a fuselage 106. In various embodiments, within the fuselage is a passenger cabin 107. In various embodiments, aircraft 100 also includes a starboard engine 108 connected to starboard wing 102 and a port engine 110 connected to port wing 104. In various embodiments, aircraft 100 also includes a starboard horizontal stabilizer 112, a port horizontal stabilizer 114, and a vertical stabilizer 116. In various embodiments, aircraft 100 also includes aircraft windows 118.

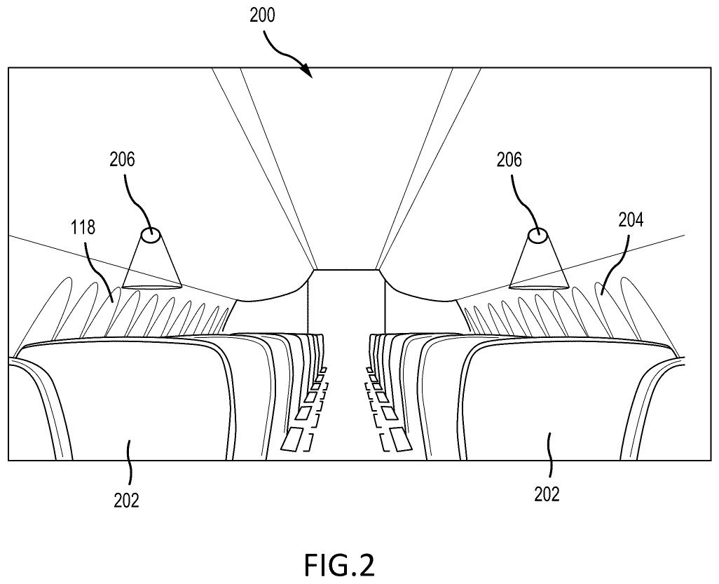

Referring now to FIG. 2, an interior view of a passenger cabin of an aircraft is illustrated, in accordance with various embodiments. In various embodiments, the passenger cabin 200, which may a passenger cabin such as passenger cabin 107 of FIG. 1, may include a plurality of passenger seats 202 configured for a passenger to situate themselves in, a plurality of aircraft windows 118 for a passenger or a crew members to see outside of the aircraft, and a plurality of overhead passenger service units (“PSUs”) 206 that provide for reading lights, air, or calling cabin service personnel, among other features described hereafter.

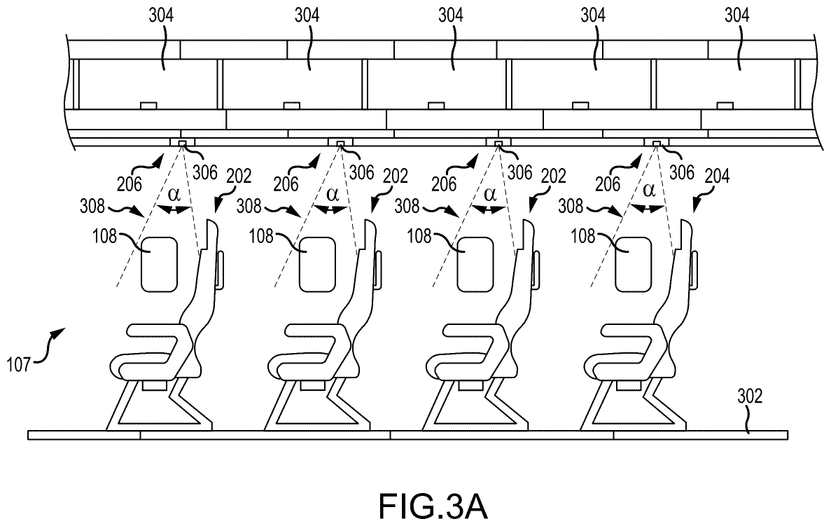

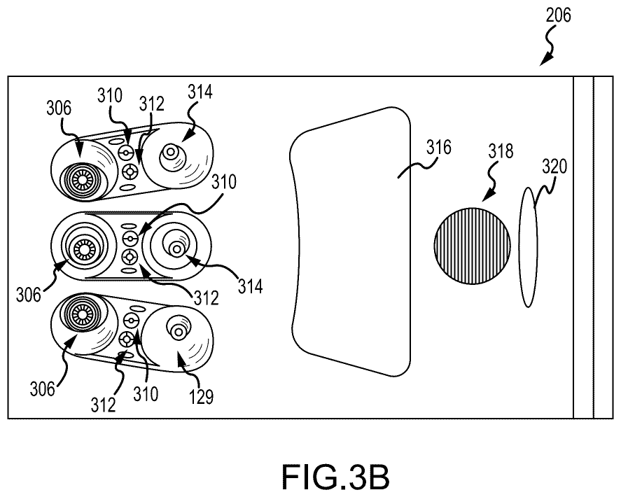

Referring now to FIG. 3A, in accordance with various embodiments, a schematic longitudinal cross-sectional view of a section of the passenger cabin 107 of the aircraft 100 of FIG. 1 is illustrated. In n the illustration, four passenger seats 202 are shown in FIG. 3A. In various embodiments, the passenger seats 202 are mounted to a floor 302 of the passenger cabin 107. Each of the passenger seats 202 depicted belong to a different seat row. For each of the seat rows, an aircraft window 118 is provided, which allows the passengers to view outside of the aircraft 100. Further, a plurality of overhead baggage compartments 304 are shown. The overhead baggage compartments 304 provide storage space for the passengers' baggage. Each seat row includes a plurality, for example two or three, passenger seats 202, which are arranged next to each other, perpendicular to the viewing plane of FIG. 3A. The additional passenger seats 202 of each seat row are not visible in FIG. 3A, as they are arranged behind and therefore hidden by the depicted first passenger seats (aisle seats) 202 of each seat row.

Passenger service units (“PSUs”) 206 comprising aircraft passenger reading lights 306 according to various embodiments are provided above the passenger seats 202. Details of the passenger service units 206 will be discussed further below with reference to FIG. 3B. Typically, a single aircraft passenger reading light 306 is associated with each of the passenger seats 202, respectively. In particular, each aircraft passenger reading light 306 may be associated with one of the passenger seats 202 and may be configured for emitting a light output 308 towards the associated passenger seat 202. The light output 308 of the aircraft passenger reading lights 306 may be configured for providing sufficient illumination to each passenger seat 202, without providing un-necessary illumination of neighboring passenger seats 202. In consequence, the specifics of the light output 308, in particular an opening angle α of a light cone, which is output by each aircraft passenger reading light 306, may depend on the distance between the aircraft passenger reading light 306 and the associated passenger seat 202. A smaller distance between the aircraft passenger reading light 306 and the associated passenger seat 202 may be dealt with via a larger opening angle α of the light output 308, and vice versa.

In order to allow for employing the same type of aircraft passenger reading lights 306 in different passenger cabin 107, in particular in passenger cabin 107 having different geometries and seat configurations, which results in different distances between the aircraft passenger reading lights 306 and the respectively associated passenger seats 202, it may be desirable that the light outputs 308, provided by the aircraft passenger reading lights 306, are adjustable to different distances between the aircraft passenger reading lights 306 and the respectively associated passenger seats 202.

Referring now to FIG. 3B, in accordance with various embodiments, a schematic view of an overhead passenger service unit (“PSU”) 206, which may be arranged above the passenger seats 202 of a single seat row, as illustrated in FIG. 3A, is illustrated. FIG. 3B illustrates the passenger service unit 206, as seen by a passenger sitting on a passenger seat 202 below the passenger service unit 206. In various embodiments, on the side that is shown to the left in FIG. 3B, the passenger service unit 206 includes a row of three adjustable aircraft passenger reading lights 306 arranged next to each other. In various embodiments, six electrical switches 310, 312 are provided to the right side of the aircraft passenger reading lights 306, a respective pair of two switches 310, 312 next to each of the aircraft passenger reading lights 306. A first one of the switches 312 of each pair is configured for switching the adjacent aircraft passenger reading light 306 on and off, and the second switch 310 of each pair is configured for triggering a signal for calling a crew member.

A row of three adjacent gaspers 314 is provided next to the switches 310, 312. Adjacent to the gaspers 314, is a movable door 316, which covers a compartment housing, for example, three oxygen masks. The compartment and the oxygen masks are not visible in FIG. 3B, as they are covered by the movable door 316. In the event of pressure loss within the passenger cabin 107, the movable door 316 will open, allowing the oxygen masks to drop out the compartment. Each of the passengers sitting on a passenger seat 202 below the passenger service unit 206 may grasp one of the oxygen masks. After being activated, an oxygen generator, which is not shown in the figures, will supply the oxygen masks with oxygen.

On the side opposite to the movable door 316, a grid 318 is formed within the passenger service unit 206. A loudspeaker (not shown), which may be used for delivering acoustic announcements to the passengers, may be arranged behind said grid 318. Next to the grid 318, is a display panel 320, which may be configured for selectively showing a plurality of visual signs (not shown), such as “no-smoking” or “fasten your seat belt”. The display panel 320 may be illuminated from behind, in order to deliver visual information to the passengers sitting on the passenger seats 202 below the passenger service unit 206.

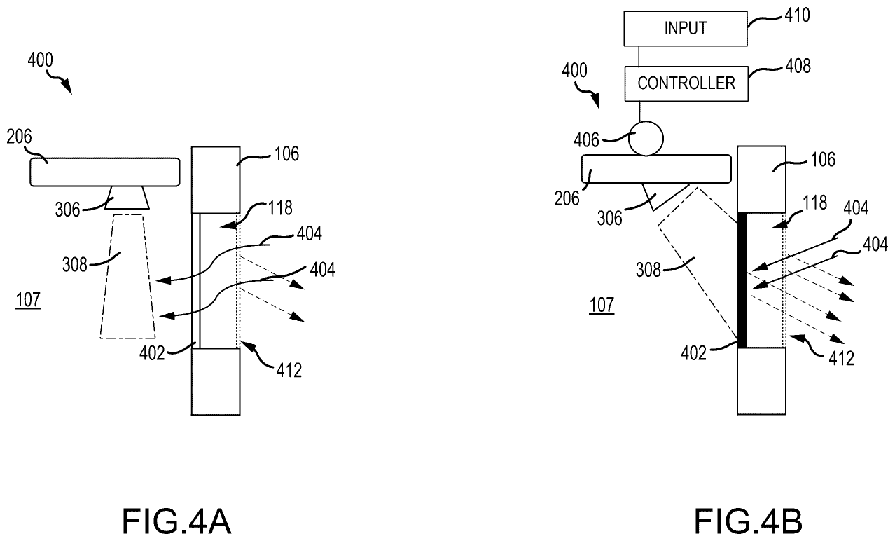

Referring now to FIGS. 4A and 4B, in accordance with various embodiments, an aircraft window shading/unshading system is illustrated. In various embodiments, the fuselage 106 of an aircraft, such as aircraft 100 of FIG. 1, includes an aircraft window 118 and the aircraft window shading/unshading system 400. In various embodiments, with reference to FIG. 4A, the aircraft window 118 is coated with a photochromatic material 402 that is in a first state, i.e. a transparent and/or substantially transparent to a range of visible light wavelengths state, thereby allowing natural light 404 from outside the aircraft to enter a passenger cabin 107 of the aircraft as well as allow viewing outside the aircraft from the passenger cabin 107. In various embodiments, the photochromatic material 402 is responsive to a focused predetermined range of light wavelengths, such as certain visible or invisible light wavelengths, referred to hereafter as a trigger light wavelength, provided by an aircraft interior light, such as aircraft passenger reading lights 306 in the passenger service unit 206, a cabin light, or a dedicated light source, among others. In various embodiments, the trigger light wavelength may be in a range of 100 nm to 1 mm. The following description utilizes the aircraft passenger reading light 306 as providing the trigger light wavelength only as one example. In various embodiments, responsive to the passenger utilizing the aircraft passenger reading light 306 such that the light output 308 is positioned away from the aircraft window 118 and photochromatic material 402, then the photochromatic material 402 is configured to stay transparent and/or substantially transparent to a range of visible light wavelengths, thereby allowing natural light 404 from outside the aircraft to enter the passenger cabin 107 of the aircraft as well as allow viewing outside the aircraft from the passenger cabin 107.

With reference to FIG. 4B, in various embodiments, responsive to the aircraft passenger reading light 306 being focused towards the photochromatic material 402, either by the passenger or under control of crew member-controlled mechanism 406 as commanded by controller 408 based on input 410 from a crew member, such that the photochromatic material 402 on the window is exposed to the light output 308 of the aircraft passenger reading light 306 including the trigger light wavelength, the photochromatic material 402 transitions from the first state, i.e. the transparent and/or substantially transparent to a range of visible light wavelengths state, i.e. 80% or greater transmissivity to visible light, to a second state, i.e. an opaque and/or substantially opaque to a range of visible light wavelengths state, i.e. 20% or less transmissivity to visible light, thereby preventing the natural light 404 from outside the aircraft from entering the passenger cabin 107 of the aircraft as well as preventing viewing outside of the aircraft from the passenger cabin 107. In various embodiments, aircraft passenger reading light 306 may include a visible or invisible light source with a trigger light wavelength. In various embodiments, the trigger light wavelength may be in a range of 100 nm to 1 mm.

As stated previously, the aircraft passenger reading light 306 may be coupled to the crew member-controlled mechanism 406. In that regard, responsive to an event, such as taxiing, takeoff, landing, or emergency, among others, in various embodiments, a crew member May provide input 410 to the controller 408 that sends a command to the crew member-controlled mechanism 406, which may be a motor, actuator, or other mechanism, that, responsive to receiving the command, turns the aircraft passenger reading light 306 away from the photochromatic material 402 on the aircraft window 118 thereby causing the photochromatic material 402 to transition from opaque and/or substantially opaque to a range of visible light wavelengths to transparent and/or substantially transparent to a range of visible light wavelengths, which reduces passenger involvement and crew member manual checks. In various embodiment, as illustrated in FIGS. 4A and 4B, a polarizer, color filter or reflective coating 412 may can be added on outside the aircraft window 118 to reflect some of the natural light 404, specifically, the trigger light wavelength, to avoid transitioning of photochromatic material 402 by bright sunlight.

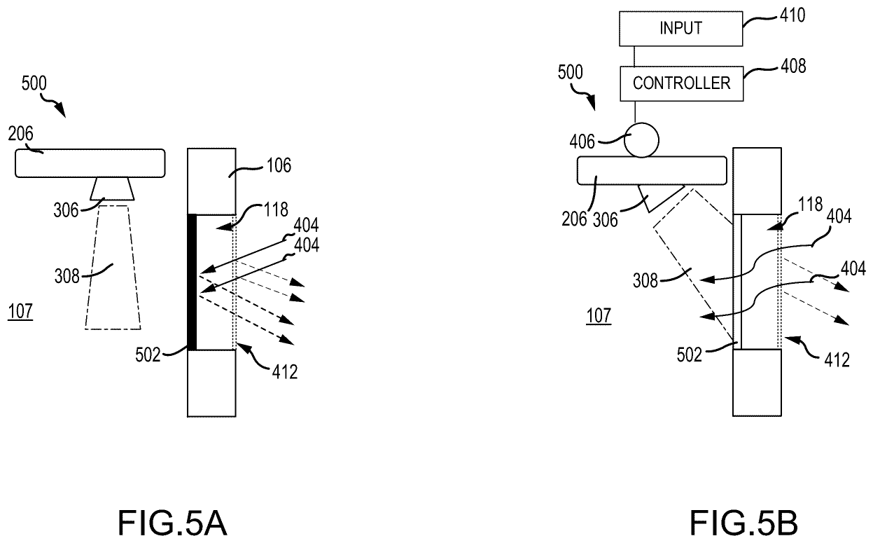

Referring now to FIGS. 5A and 5B, in accordance with various embodiments, an aircraft window shading/unshading system is illustrated. In various embodiments, the fuselage 106 of an aircraft, such as aircraft 100 of FIG. 1, includes an aircraft window 118 and the aircraft window shading/unshading system 500. In various embodiments, with reference to FIG. 5A, the aircraft window 118 is coated with a photochromatic material 502 that is in a first state, i.e. an opaque and/or substantially opaque to a range of visible light wavelengths state, thereby blocking the natural light 404 from outside the aircraft entering the passenger cabin 107 of the aircraft as well as blocking a view outside of the aircraft from the passenger cabin 107. In various embodiments, the photochromatic material 502 is responsive to a focused predetermined range of light wavelengths, such as those certain visible or invisible light wavelengths, referred to hereafter as a trigger light wavelength, provided by an aircraft interior light, such as aircraft passenger reading light 306 in the passenger service unit 206, a cabin light, or a dedicated light source, among others. In various embodiments, the trigger light wavelength may be in a range of 100 nm to 1 mm. The following description utilizes the aircraft passenger reading light 306 as providing the trigger light wavelength only as one example. In various embodiments, responsive to the passenger utilizing the aircraft passenger reading light 306 such that the light output 308 is positioned away from the aircraft window 118 and photochromatic material 502, then the photochromatic material 502 is configured to stay opaque and/or substantially opaque to a range of visible light wavelengths, thereby preventing the natural light 404 from outside of the aircraft from entering the passenger cabin 107 of the aircraft as well as blocking the view outside the aircraft from the passenger cabin 107.

With reference to FIG. 5B, in various embodiments, responsive to the aircraft passenger reading light 306 being focused towards the photochromatic material 502, either by the passenger or under control of crew member-controlled mechanism 406 as commanded by controller 408 based on input 410 from a crew member, such that the photochromatic material 502 on the window is exposed to the light output 308 of the aircraft passenger reading light 306 including the trigger light wavelength, the photochromatic material 402 transitions from the first state, i.e. the opaque and/or substantially opaque to a range of visible light wavelengths state, i.e. 20% or less transmissivity to visible light, to a second state, i.e. a transparent and/or substantially transparent to a range of visible light wavelengths state, i.e. 80% or greater transmissivity to visible light, thereby allowing the natural light 404 from outside of the aircraft to enter the passenger cabin 107 of the aircraft as well as allowing viewing outside of the aircraft from the passenger cabin 107. In various embodiments, aircraft passenger reading light 306 may include a visible or invisible light source with a trigger light wavelength. In various embodiments, the trigger light wavelength may be in a range of 100 nm to 1 mm.

As stated previously, the aircraft passenger reading light 306 may be coupled to the crew member-controlled mechanism 406. In that regard, responsive to an event, such as taxiing, takeoff, landing, or emergency, among others, in various embodiments, a crew member may provide input 410 to the controller 408 that sends a command to the crew member-controlled mechanism 406, which may be a motor, actuator, or other mechanism, that, responsive to receiving the command, turns the aircraft passenger reading light 306 towards the photochromatic material 502 on the aircraft window 118 thereby causing the photochromatic material 502 to transition from opaque and/or substantially opaque to a range of visible light wavelengths to transparent and/or substantially transparent to a range of visible light wavelengths, which reduces passenger involvement and crew member manual checks. In various embodiment, as illustrated in FIGS. 5A and 5B, a polarizer, color filter or reflective coating 412 may can be added on outside of the aircraft window 118 to reflect some of the natural light 404, specifically, the trigger light wavelength, to avoid transitioning of photochromatic material 502 by bright sunlight.

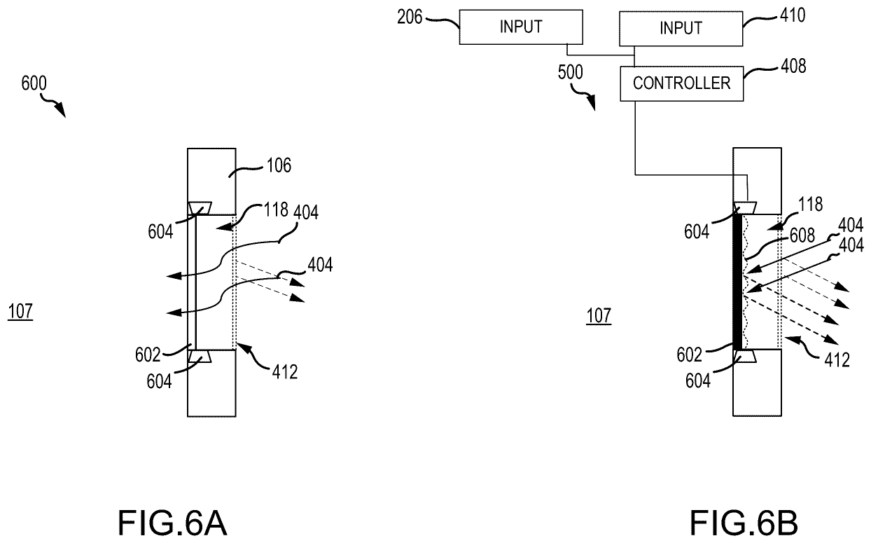

Referring now to FIGS. 6A and 6B, in accordance with various embodiments, an aircraft window shading/unshading system is illustrated. In various embodiments, the fuselage 106 of an aircraft, such as aircraft 100 of FIG. 1, includes an aircraft window 118 and the aircraft window shading/unshading system 600. In various embodiments, with reference to FIG. 6A, the aircraft window 118 is coated with a photochromatic material 602 that is in a first state, i.e. a transparent and/or substantially transparent to a range of visible light wavelengths state, thereby allowing natural light 404 from outside the aircraft to enter a passenger cabin 107 of the aircraft as well as allow viewing outside the aircraft from the passenger cabin 107. In various embodiments, the photochromatic material 602 is responsive to a focused predetermined range of light wavelengths, such as certain visible or invisible light wavelengths, referred to hereafter as a trigger light wavelength, provided by an aircraft light, such as edge lights 604. In various embodiments, the edge lights 604 are configured circumferentially around the portion of the aircraft window glass 118 where the photochromic material 602 is coupled to the aircraft window glass 118, around aircraft window 118 between a side of the photochromic material 602 facing the exterior of the aircraft and an exterior portion of the aircraft window glass 118, or around the interior portion of the aircraft window glass 118 on a side of the photochromic material 602 facing an interior of the aircraft. In various embodiments, the trigger light wavelength may be in a range of 100 nm to 1 mm. In various embodiments, the edge lights 604 may be activated by the passenger via a switch on the passenger service unit 206 or a crew member via input 410. In various embodiments, responsive to the passenger of crew member not activating the edge lights 604, the photochromatic material 602 is configured to stay transparent and/or substantially transparent to a range of visible light wavelengths, thereby allowing natural light 404 from outside the aircraft to enter the passenger cabin 107 of the aircraft as well as allow viewing outside the aircraft from the passenger cabin 107.

With reference to FIG. 6B, in various embodiments, responsive to the passenger providing an activation indication via the passenger service unit 206, the controller 408 activates the edge lights 604 such that the photochromatic material 602 on the window is exposed to the light output 608 of the edge lights 604 including the trigger light wavelength, the photochromatic material 402 transitions from the first state, i.e. the transparent and/or substantially transparent to a range of visible light wavelengths state, i.e. 80% or greater transmissivity to visible light, to a second state, i.e. an opaque and/or substantially opaque to a range of visible light wavelengths state, i.e. 20% or less transmissivity to visible light, thereby preventing the natural light 404 from outside the aircraft from entering the passenger cabin 107 of the aircraft as well as preventing viewing outside of the aircraft from the passenger cabin 107. In various embodiments, the edge lights 604 may include a visible or invisible light source with a trigger light wavelength. In various embodiments, the trigger light wavelength may be in a range of 100 nm to 1 mm.

As stated previously, the edge lights 604 may be coupled to the controller 408. In that regard, responsive to an event, such as taxiing, takeoff, landing, or emergency, among others, in various embodiments, a crew member may provide input 410 to the controller 408 that sends a command, in one embodiment, to deactivate all of the edge lights 604 thereby causing the photochromatic material 602 to transition from opaque and/or substantially opaque to a range of visible light wavelengths to transparent and/or substantially transparent to a range of visible light wavelengths, which reduces passenger involvement and crew member manual checks. In various embodiment, as illustrated in FIGS. 6A and 6B, a polarizer, color filter or reflective coating 412 may can be added on outside the aircraft window 118 to reflect some of the natural light 404, specifically, the trigger light wavelength, to avoid transitioning of photochromatic material 402 by bright sunlight.

Accordingly, by removing physical shades, shutters, and/or blinds, the systems of the illustrative embodiments provide for automatic transition of windows in events, such as taxiing, takeoff, landing, or emergency, among others. The systems of the illustrative embodiments utilize existing mechanisms within the aircraft with only minor modifications as well as reduces a weight of the aircraft and assembly time while fulfilling both allowing/preventing light to enter the cabin of the aircraft as well as allowing/preventing viewing outside of the cabin of the aircraft. Utilizing the systems of the illustrative embodiments, a crew member has an ability to turn transition the photochromatic material without passenger assistance.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A system for shading or unshading of an aircraft window, the system comprising:
the aircraft window;
a photochromatic material coupled to the aircraft window; and
a light source within a cabin of an aircraft, wherein, responsive to exposing the photochromatic material to the light source, the photochromatic material transitions from a first state to a second state.

2. The system of claim 1, wherein the first state is a transparent and/or substantially transparent to a range of visible or invisible light wavelengths state and wherein the second state is an opaque and/or substantially opaque to the range of visible or invisible light wavelengths state.

3. The system of claim 1, wherein the first state is an opaque and/or substantially opaque to a range of visible or invisible light wavelengths state and wherein the second state is a transparent and/or substantially transparent to the range of visible or invisible light wavelengths state.

4. The system of claim 1, wherein the photochromatic material is coupled to an interior of the aircraft window and wherein the photochromatic material is responsive to a light wavelength in a range of 100 nm to 1 mm.

5. The system of claim 1, wherein the light source is at least one of an aircraft passenger reading light, a cabin light, an edge light, or a dedicated light source and wherein the light source outputs a light wavelength in a range of 100 nm to 1 mm.

6. The system of claim 1, wherein the photochromatic material is exposed to the light source by a passenger directing the light source either towards or away from the photochromatic material.

7. The system of claim 1, further comprising:
a crew member-controlled mechanism, wherein the crew member-controlled mechanism is coupled to the light source and wherein the photochromatic material is exposed to the light source by the crew member-controlled mechanism directing the light source either towards or away from the photochromatic material.

8. The system of claim 7, wherein the crew member-controlled mechanism is at least one of an actuator or a motor.

9. The system of claim 7, further comprising:
a controller, wherein the controller is configured to:
receive an input from a crew member of the aircraft; and
send a command to the crew member-controlled mechanism cause the crew member-controlled mechanism to direct a light of the light source on the photochromatic material.

10. The system of claim 1, further comprising:
a color filter or reflective coating, wherein the color filter or reflective coating is coupled to an exterior of the aircraft window.

11. An aircraft, the aircraft comprising:
a plurality of aircraft windows;
a photochromatic material coupled to each of the plurality of aircraft windows; and
a plurality of light sources within a cabin of the aircraft, wherein, responsive to exposing the photochromatic material on each of the plurality of aircraft windows to a respective one of the plurality of light sources, the photochromatic material transitions from a first state to a second state.

12. The aircraft of claim 11, wherein the first state is a transparent and/or substantially transparent to a range of visible or invisible light wavelengths state and wherein the second state is an opaque and/or substantially opaque to the range of visible or invisible light wavelengths state.

13. The aircraft of claim 11, wherein the first state is an opaque and/or substantially opaque to a range of visible or invisible light wavelengths state and wherein the second state is a transparent and/or substantially transparent to the range of visible or invisible light wavelengths state.

14. The aircraft of claim 11, wherein the photochromatic material is coupled to an interior of each of the plurality of aircraft windows and wherein the photochromatic material is responsive to a light wavelength in a range of 100 nm to 1 mm.

15. The aircraft of claim 11, wherein each light source of the plurality of light sources is at least one of an aircraft passenger reading light, a cabin light, an edge light, or a dedicated light source and wherein the light source outputs a light wavelength in a range of 100 nm to 1 mm.

16. The aircraft of claim 11, wherein the photochromatic material on each of the plurality of aircraft windows is exposed to a respective light source of the plurality of light sources by a passenger directing the respective light source either towards or away from the photochromatic material on a respective aircraft window of the plurality of aircraft windows.

17. The aircraft of claim 11, further comprising:
a plurality of crew member-controlled mechanisms, wherein each crew member-controlled mechanism of the plurality of crew member-controlled mechanisms is coupled to a respective light source of the plurality of light sources and wherein the photochromatic material on each of the plurality of aircraft windows is exposed to the respective light source by a respective crew member-controlled mechanism directing the respective light source either towards or away from the photochromatic material on a respective aircraft window of the plurality of aircraft windows.

18. The aircraft of claim 17, wherein the plurality of crew member-controlled mechanisms are at least one of an actuator or a motor.

19. The aircraft of claim 17, further comprising:
a controller, wherein the controller is configured to:
receive an input from a crew member of the aircraft; and
send a command to each of the plurality of crew member-controlled mechanisms causing the plurality of crew member-controlled mechanisms to direct a light of a respective light source of the plurality of light sources on the photochromatic material of a respective aircraft window of the plurality of aircraft windows.

20. The aircraft of claim 11, further comprising:
a color filter or reflective coating coupled to an exterior of each of the plurality of aircraft windows.
